(19) United States
(12) Patent Application Publication
(10) Pub. No.: US 2010/0164835 A1
(43) Pub. Date: Jul. 1, 2010

(54) Electrical connector assembly with antenna function

(75) Inventors: Lung-Sheng Tai, Tu-cheng (TW); Wen-Fong Su, Tu-cheng (TW); Hsieh-Sheng Tseng, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/319,082

(22) Filed: Dec. 30, 2008

(51) Int. Cl. H01Q 1/50; H01Q 1/38

(52) U.S. Cl. 343/906; 343/700 MS

(57) ABSTRACT

An electrical connector assembly (100) with antenna function comprising: an electrical connector (20) comprising a metal shell (21); a metal patch (30) connecting to the metal shell (20) and comprising a radiating element (33) and a connecting element (31); an insulating support element (40) locating between the radiating element and the metal shell; the radiating element locating on top of the metal shell; the connecting element connecting to the metal shell that serve as a grounding element; the radiating element, the connecting element, and the metal shell forming an antenna that serves as a medium for transmission and reception of electromagnetic signals.

### BACKGROUND OF THE INVENTION

1. Field of the Invention

The present invention relates to an electrical connector assembly, and more particularly to electrical connector assembly having antenna function.

2. Description of Prior Art

Personal computer technologies have been embraced in many portable electronics devices including: cellular telephones, personal data assistants (PDAs), laptop computers, MP3 players, pen-drives, digital video cameras, as well as other mobile devices. Many of the portable electronic devices can be configured to operate with various peripheral devices such as a computer mouse, a computer writing tablet, a digital camera, as well as others. Moreover, many of the portable electronic devices are also configured to interface with personal computers through a standard interface.

The need for standardization in computer related interfaces, as well as the need for high-speed communication interfaces has lead to the development of the universal serial bus (USB). The USB interface is a high-speed communication protocol that permits devices to communicate at data rates on the order of 48 Mb/s. A revised USB interface such as the USB 2.0 specification can operate at even higher speeds that are on the order of 480 Mb/s. The high speed USB interface has lead to widespread acceptance of external peripheral devices such as USB HDD systems, USB Ethernet devices, USB compact disk writing devices (e.g., CD/RW), as well as other devices.

Today, more and more electronic devices, such as personal computers, notebook computers, electronic appliances, and the like, are normally equipped with an internal antenna that serves as a medium for transmission and reception of electromagnetic signals, such as data, audio, image, and so on. PIFA (Planar Inverted-F Antenna) is a kind of mini antenna usually used in the electronic devices. PIFA has compact structure, light weight, perfect impedance match, desired horizontal polarization and vertical polarization, and is easy to achieve multi-frequency. So, more and more PIFAs are used in the electronic devices. Electrical connector assembly and the antenna of the traditional electronic devices are two separate components. Accordingly, the electrical connector and the antenna respectively occupy inner space of the electronic devices. However, electronic devices trend to miniaturization developing. For saving inner space of the electronic devices, many components being integrated is a question.

Hence, in this art, an electrical connector assembly with antenna function to overcome the above-mentioned disadvantages of the prior art will be described in detail in the following embodiment.

### SUMMARY OF THE INVENTION

An object of the present invention is to provide an electrical connector assembly which has antenna function.

To achieve the aforementioned object, the present invention provides an electrical connector assembly with antenna function comprising: an electrical connector comprising a metal shell; a metal patch connecting to the metal shell and comprising a radiating element and a connecting element; an insulating support element locating between the radiating element and the metal shell; the radiating element locating on top of the metal shell; the connecting element connecting to the metal shell that serve as a grounding element; the radiating element, the connecting element, and the metal shell forming an antenna that serves as a medium for transmission and reception of electromagnetic signals.

Additional novel features and advantages of the present invention will become apparent by reference to the following detailed description when taken in conjunction with the accompanying drawings.

### BRIEF DESCRIPTION OF THE DRAWINGS

FIG. 1 is a perspective view of an electrical connector assembly with antenna in accordance with a preferred embodiment of the present invention;

FIG. 2 is an exploded, perspective view of FIG. 1

FIG. 3 is a view similar to FIG. 2, but from a different aspect; and

FIG. 4 is a test chart recording for the antenna of the in accordance with a preferred embodiment of the present invention, showing Voltage Standing Wave Ratio (VSWR) of frequency band.

### DETAILED DESCRIPTION OF THE INVENTION

Reference will now be made in detail to the preferred embodiment of the present invention.

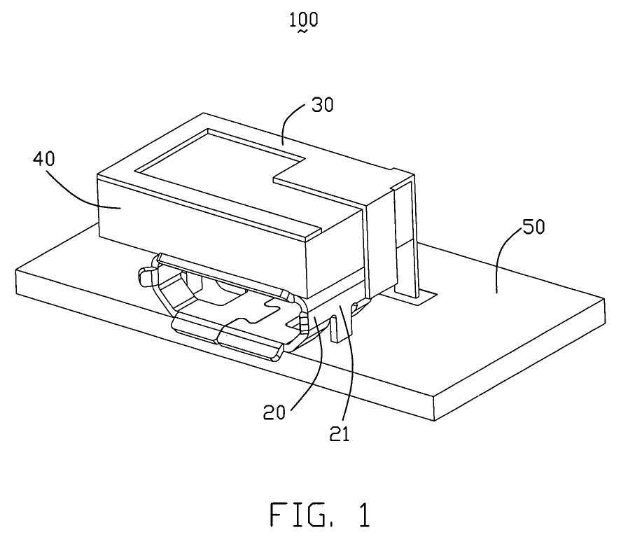

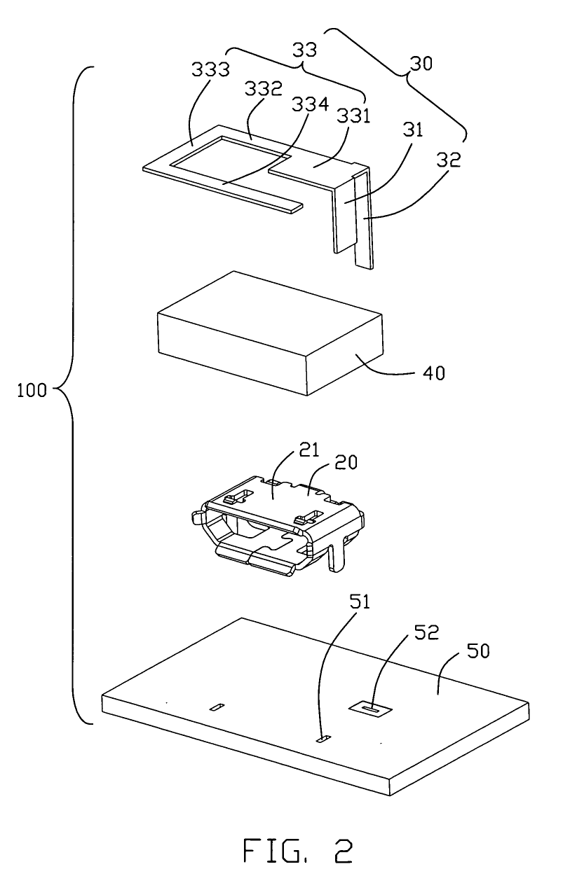

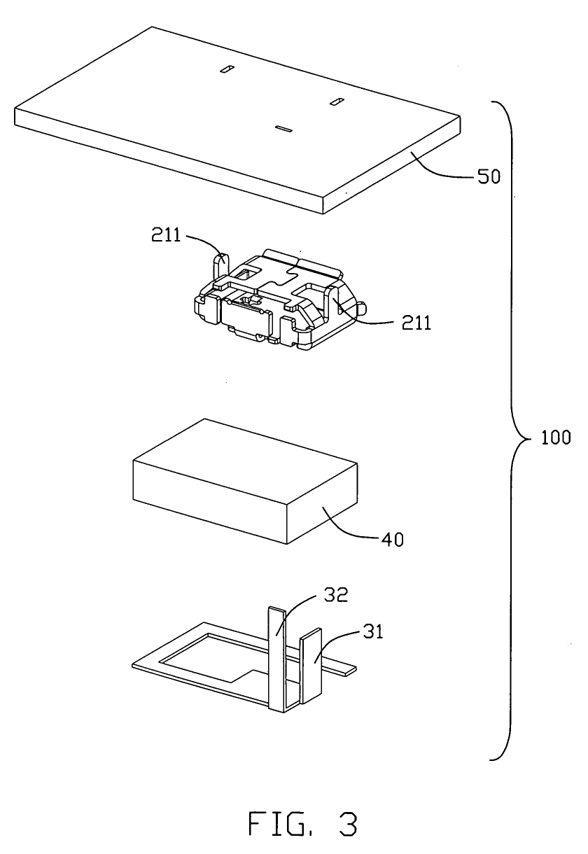

Referring to FIGS. 1-3, an electrical connector assembly 100 with antenna function in accordance with a preferred embodiment of the present invention comprises a micro USB electrical connector 20, a metal patch 30, an insulating support element 40, and a PCB 50.

The USB electrical connector 20 comprises an insulating body (not shown), several contacts (not shown) received in the insulating body, and a metal shell 21 covering the insulating body. The metal shell 21 comprises a welding element 211 extending vertically and downwardly from a bottom surface of the metal shell 21.

The metal patch 30 connects to the metal shell 21 of the USB connector 20. Accordingly, the metal patch 30 and the metal shell form an antenna that serves as a medium for transmission and reception of electromagnetic signals. The metal patch 30 comprises a connecting element 31 lying in a first plane and connecting to the metal shell 21, a radiating element 33 connecting to the connecting element 31, a feeding element 32 extending from a joint of the connecting element 31 and the radiating element 33. The radiating element 33 comprises a first rectangle-shape radiating branch 331, a second radiating branch 332 extending from an end of the first radiating branch 331, a third radiating branch 333 extending vertically from an end of the second radiating branch 332, and a fourth radiating branch 334 extending from an end of the third radiating branch 333. The third radiating branch 333 is vertical to the second radiating branch 332 and the fourth radiating branch 334. The second radiating branch 332 is parallel to the fourth radiating branch 334. The first, second, third, and fourth radiating branches lie in a second plane. The second plane is vertical to the first plane. The feeding element 32 is vertical to the radiating branch 331. The electrical connector assembly is mounted on the PCB 50. The welding element 211 of the electrical connector 20 and the feeding element 32 are soldered respectively to suitable circuit of the PCB 50.

The insulating support element 40 is a rectangle. The radiating element 33 locates on the top surface of the insulating support element 40. The connecting element 31 clings to a side surface of the insulating support element 40. The feeding element 32 clings to a back surface of the insulating support element 40.

The PCB 50 comprises a pair of first slot 51 for receiving the welding element 211, a second slot 52 for receiving the feeding element 32, and feeding circuit and grounding circuit (not shown). The metal shell 21 electrically connects to the grounding circuit. The radiating element 33 electrically connects to the feeding circuit.

The insulating support element 40 locates between the electrical connector 20 and the radiating element 33. The electrical connector 20 locates between the insulating support element 40 and the PCB 50.

The electrical connector 20 of the present invention is not limited to the micro USB connector of the preferred embodiment, other types electrical connector as well as used in present invention, such as USB connector, HDMI connector, IEEE1394 connector and so on.

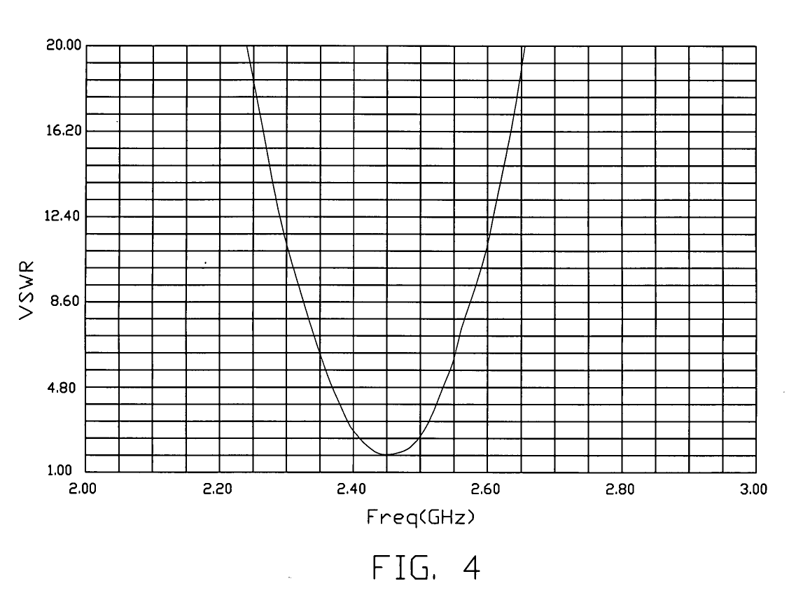

FIG. 4 is a test chart of Voltage Standing Wave Ratio of the electrical connector assembly 100 as an antenna. Referring to FIG. 4, operating frequency band of the electrical connector assembly 100 as an antenna are 2.4 GHz-2.5 GHz.

What is claimed is:

1. An electrical connector assembly with antenna function, comprising:
an electrical connector comprising a metal shell;
a metal patch connecting to the metal shell and comprising a radiating element and a connecting element;
an insulating support element locating between the radiating element and the metal shell; wherein
the radiating element locates on top of the metal shell; the connecting element connects to the metal shell that serve as a grounding element; the radiating element, the connecting element, and the metal shell form an antenna that serves as a medium for transmission and reception of electromagnetic signals.

2. The electrical connector assembly as claimed in claim 1, wherein said electrical connector assembly comprises a PCB having a feeding circuit and a grounding circuit.

3. The electrical connector assembly as claimed in claim 2, wherein said electrical connector is mounted on the PCB.

4. The electrical connector assembly as claimed in claim 2, wherein said metal patch comprises a feeding element extending from a joint of the radiating element and the connecting element.

5. The electrical connector assembly as claimed in claim 2, wherein said feeding element electrically connects to the feeding circuit.

6. The electrical connector assembly as claimed in claim 2, wherein said electrical connector locates between the insulating support element and the PCB.

7. The electrical connector assembly as claimed in claim 2, wherein said metal shell comprises a pair of welding elements soldering to the PCB.

8. The electrical connector assembly as claimed in claim 4, wherein said feeding element is soldered to the PCB and electrically connects to the feeding circuit.

9. The electrical connector assembly as claimed in claim 1, wherein said radiating element comprises a first rectangle-shape radiating branch, a second radiating branch extending from an end of the first radiating branch, a third radiating branch extending vertically from an end of the second radiating branch, and a fourth radiating branch extending from an end of the third radiating branch.

10. The electrical connector assembly as claimed in claim 9, wherein said third radiating branch is vertical to the second radiating branch and the fourth radiating branch; the second radiating branch is parallel to the fourth radiating branch.

11. The electrical connector assembly as claimed in claim 1, wherein said connecting element lies in a first plane.

12. The electrical connector assembly as claimed in claim 11, wherein said first, second, third, and fourth radiating branches lie in a second plane.

13. The electrical connector assembly as claimed in claim 12, wherein said second plane is vertical to the first plane.

14. The electrical connector assembly as claimed in claim 1, wherein said radiating element clings to a top surface of the insulating support element; the connecting element clings to a side surface of the insulating support element.

15. An electrical connector assembly comprising:
a printed circuit board;
an electrical connector mounted upon the printed circuit board and including a metallic shell having a mounting leg mechanically and electrically connected to the printed circuit board;
an antenna made of sheet metal standing above the connector and spaced from the shell, said antenna having a first portion electrically and mechanically engaging the shell for grounding, and a second portion electrically and mechanically connected to a feeding circuit of the printed circuit board for radiation.

16. The assembly as claimed in claim 15, wherein an insulating support element is sandwiched between the antenna and the shell in a vertical direction for supporting said antenna.

17. The assembly as claimed in claim 16, wherein said insulative support member, said connector and said antenna commonly have a similar width.

18. The assembly as claimed in claim 16, wherein said insulative support member is seated upon a top wall of the shell without touching the printed circuit board.

19. The assembly as claimed in claim 15, wherein said connector and said antenna have a similar width.
